(19) United States
(12) Patent Application Publication
(10) Pub. No.: US 2007/0019436 A1
(43) Pub. Date: Jan. 25, 2007

(54) Light guide plate with V-shaped grooves and backlight module incorporating same

(75) Inventors: Hsin-Ming Chen, Miao-Li (TW); Yu-Ju Hsu, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/491,582

(22) Filed: Jul. 24, 2006

(30) Foreign Application Priority Data
Jul. 22, 2005 (TW) 94212484

(51) Int. Cl. F21V 7/04

(52) U.S. Cl. 362/615

(57) ABSTRACT

An exemplary light guide plate (12) includes a substrate (120) having an emitting surface (124), and a plurality of parallel V-shaped grooves (126) provided at the emitting surface. Each of the V-shaped grooves maintains an oblique angle relative to a long side of the substrate, and the angle is in the range from 5° to 44.9°. An associated device employing the light guide plate can provide good viewing performance.

### FIELD OF THE INVENTION

The present invention relates to light guide plates including those used in backlight modules, and more particularly to a light guide plate with V-shaped grooves configured to achieve enhanced light output.

### GENERAL BACKGROUND

Liquid crystal displays (LCDs) are commonly used as display devices for compact electronic apparatuses, because they not only provide good quality images with little power but are also very thin. The liquid crystal molecules in a liquid crystal display do not emit any light themselves. The liquid crystal molecules have to be lit by a light source so as to clearly and sharply display text and images. Thus, a backlight module is generally needed for a liquid crystal display.

Referring to FIG. 4, a typical backlight module 4 includes a brightness enhancement sheet 40, a light guide plate 42, three linear light sources 44 lying in a same horizontal plane, and a reflective sheet 46, which are disposed in that order from top to bottom. The light guide plate 42 includes a bottom surface 422 and an opposite top surface 424. The brightness enhancement sheet 40 is disposed adjacent to the top surface 424 of the light guide plate 42. The light sources 44 are disposed adjacent to the bottom surface 422 of the light guide plate 42. A top surface 402 of the brightness enhancement sheet 40 includes a plurality of parallel V-shaped prisms 404 thereat. The V-shaped prisms 404 are transversely oriented with respect to long sides of a main body of the brightness enhancement sheet 40. The top surface 424 of the light guide plate 42 includes a plurality of parallel V-shaped grooves 426 thereat. The V-shaped grooves 426 are oriented parallel to long sides of a main body of the light guide plate 42. Thus the V-shaped grooves 426 of the light guide plate 42 are oriented perpendicular to the V-shaped prisms 404 of the brightness enhancement sheet 40.

Most light beams emitted from the light sources 44 are transmitted to the light guide plate 42, and are converted by the light guide plate 42 to a surface light source at the top surface 424 thereof. The V-shaped grooves 426 of the light guide plate 42 and the V-shaped prisms 404 of the brightness enhancement sheet 40 can cooperate to guide the light beams to radiate up from the backlight module 4 within a desired range of viewing angles. This cooperative configuration of the V-shaped grooves 426 and the V-shaped prisms 404 can enhance the efficacy of the light beams output from the backlight module 4. On the other hand, because the V-shaped grooves 426 and the V-shaped prisms 404 are perpendicular to each other, any enhancement achieved is limited. Moreover, the configuration of the V-shaped grooves 426 and the V-shaped prisms 404 being oriented perpendicular to each other may result in the so-called optical interference fringe.

What is needed, therefore, is a light guide plate that can overcome the above-described deficiencies. What is also needed is a backlight module employing such a light guide plate.

### SUMMARY

In a preferred embodiment, a light guide plate includes a substrate having an emitting surface, and a plurality of parallel V-shaped grooves provided at the emitting surface. Each of the V-shaped grooves maintains an oblique angle relative to a long side of the substrate, and the angle is in the range from 5° to 44.9°. A backlight module employing the light guide plate is also provided.

Other advantages and novel features will become more apparent from the following detailed description when taken in conjunction with the accompanying drawings. In the drawings, all the views are schematic.

### BRIEF DESCRIPTION OF THE DRAWINGS

FIG. 1 is an exploded, isometric view of a backlight module according to a first embodiment of the present invention, the backlight module including a light guide plate.

FIG. 2 is a view of the light guide plate of FIG. 1 in isolation.

FIG. 3 is an exploded, isometric view of a backlight module according to a second embodiment of the present invention.

FIG. 4 is an exploded, isometric view of a conventional backlight module.

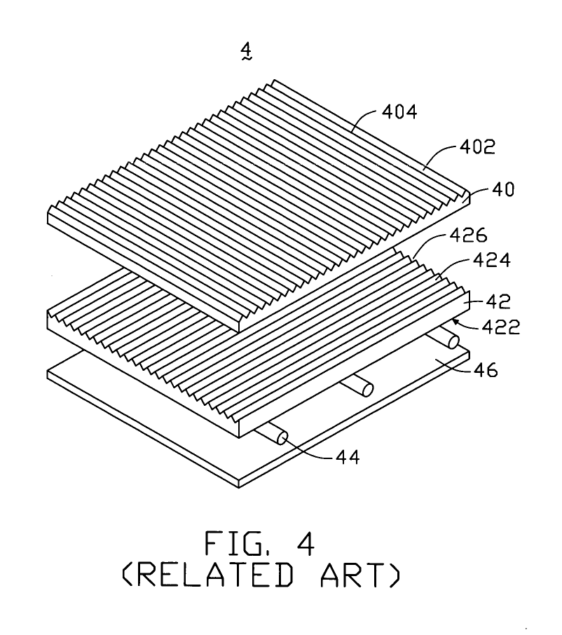

### DETAILED DESCRIPTION OF PREFERRED EMBODIMENTS

Reference will now be made to the drawings to describe the preferred embodiments in detail.

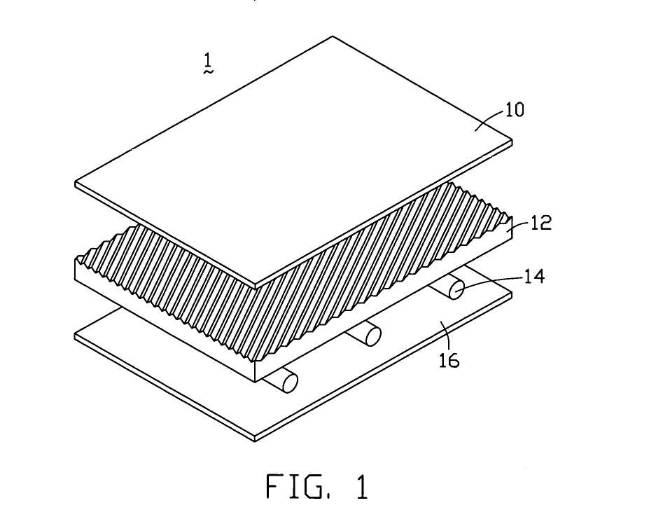

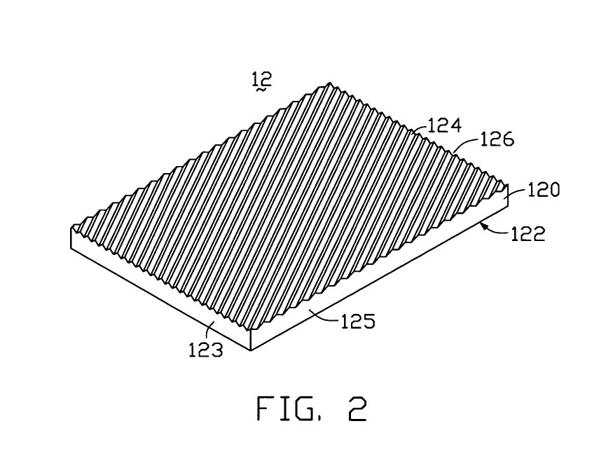

Referring to FIG. 1, a backlight module 1 according to a first embodiment of the present invention includes a diffusing sheet 10, a light guide plate 12, three linear light sources 14 lying in a same horizontal plane, and a reflective sheet 16, which are disposed in that order from top to bottom. Referring also to FIG. 2, the light guide plate 12 includes a substrate 120. The substrate 120 is substantially rectangular, and includes a bottom incident surface 122, a top emitting surface 124, a first side surface 123, and a second side surface 125. The emitting surface 124 is parallel to and opposite to the incident surface 122. The first side surface 123 and the second side surface 125 are between the incident surface 122 and the emitting surface 124, and are adjacent each other. A length of the second side surface 125 is greater than that of the first side surface 123. The light sources 14 are disposed adjacent to the incident surface 122 of the light guide plate 12. The diffusing sheet 10 is disposed adjacent to the emitting surface 124 of the light guide plate 12. The light guide plate 12 can be made from polycarbonate (PC) or polymethyl methacrylate (PMMA). The light sources 14 are linear lamps, and preferably are cold cathode fluorescent lamps (CCFLs).

A plurality of V-shaped grooves 126 are defined at the emitting surface 124 of the light guide plate 12. The V-shaped grooves 126 are integrally formed with the substrate 120, and are parallel to each other. Each of the V-shaped grooves 126 maintains an oblique angle relative to the second side surface 125. That is, each V-shaped groove 126 maintains an oblique angle relative to a long side of the substrate 120. In particular, the oblique angle is in the range from 5° to 44.9°. With this angular range, a brightness of the backlight module 1 can be increased. In a preferred embodiment, the angle is 30°. With this configuration, optical interference fringes of the backlight module 1 can be avoided.

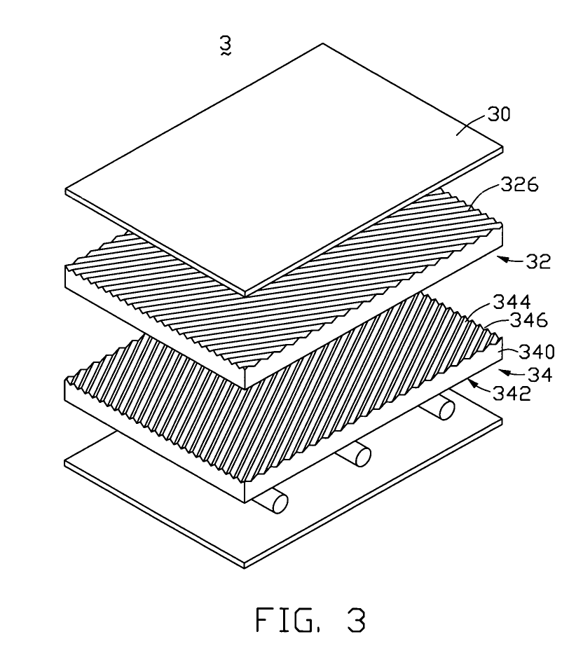

FIG. 3 is an isometric view of a backlight module according to a second embodiment of the present invention. The backlight module 3 is similar to the backlight module 1 of the first embodiment. However, the backlight module 3 further includes a brightness enhancement sheet 32 positioned between a diffusing sheet 30 and a light guide plate 34. The light guide plate 34 includes a substrate 340 having a bottom incident surface 342 and an opposite emitting surface 344. A plurality of V-shaped grooves 346 are defined at the emitting surface 344 of the light guide plate 34. The V-shaped grooves 346 are parallel to each other, and each of the V-shaped grooves 346 maintains an oblique angle relative to a long side of the substrate 340. A longest one of the V-shaped grooves 346 spans from one corner of the substrate 340 to a diagonally opposite corner of the substrate 340. Thus, all the other V-shaped grooves 346 are arranged at either side of the longest V-shaped groove 346. The oblique angle maintained by the V-shaped grooves 346 is in the range from 5° to 44.9°. The brightness enhancement sheet 32 includes a plurality of parallel V-shaped prisms 326. When the backlight module 3 is considered from above, the V-shaped prisms 326 of the brightness enhancement sheet 32 cross the V-shaped grooves 346 of the light guide plate 34.

The backlight module 3 has advantages similar to those described above in relation to the backlight module 1 of the first embodiment. Moreover, the cooperative configuration of the V-shaped prisms 326 crossing the V-shaped grooves 346 enables the backlight module 3 to provide even more enhanced optical performance.

In each of the above-described embodiments, the angle within the range from 5° to 44.9° maintained by each of the V-shaped grooves 126, 346 can be configured according to any particular application in order to improve and optimize the characteristics of brightness and view angle. Thus, an associated device such as the backlight module 1, 3 employing the light guide plate 12, 34 can provide good viewing performance.

Further and/or alternative embodiments may include the following. The light sources can be a plurality of point light sources, such as light emitting diodes (LEDs) arrayed in a matrix. The incident surface of the light guide plate can be a side surface adjacent the emitting surface. In such a case, the light sources are disposed adjacent to the side surface of the light guide plate.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A light guide plate comprising:
a substrate having an emitting surface; and
a plurality of parallel V-shaped grooves provided at the emitting surface;
wherein each of the V-shaped grooves maintains an oblique angle relative to a long side of the substrate, and the angle is in the range from 5° to 44.9°.

2. The light guide plate in claim 1, wherein the angle is approximately 30°.

3. The light guide plate in claim 1, wherein the angle is approximately 5°.

4. The light guide plate in claim 1, wherein the angle is approximately 44.9°.

5. The light guide plate in claim 1, wherein the substrate is generally rectangular.

6. The light guide plate in claim 5, wherein a longest one of the V-shaped grooves spans from one corner of the substrate to a diagonally opposite corner of the substrate.

7. The light guide plate in claim 1, wherein the V-shaped grooves are integrally formed with the substrate.

8. The light guide plate in claim 1, wherein the light guide plate is made from polycarbonate or polymethyl methacrylate.

9. A backlight module comprising:
a light guide plate comprising:
a substrate having an incident surface and an emitting surface; and
a plurality of parallel V-shaped grooves provided at the emitting surface; and
a light source disposed adjacent to the incident surface of the light guide plate;
wherein each of the V-shaped grooves maintains an oblique angle relative to a long side of the substrate, and the angle is in the range from 5° to 44.9°.

10. The backlight module in claim 9, wherein the angle is approximately 30°.

11. The backlight module in claim 9, wherein the angle is approximately 5°.

12. The backlight module in claim 9, wherein the angle is approximately 44.9°.

13. The backlight module in claim 9, wherein the substrate is generally rectangular.

14. The backlight module in claim 13, wherein a longest one of the V-shaped grooves spans from one corner of the substrate to a diagonally opposite corner of the substrate.

15. The backlight module in claim 9, wherein the V-shaped grooves are integrally formed with the substrate

16. The backlight module in claim 9, further comprising a brightness enhancement sheet adjacent the emitting surface of the light guide plate, wherein the brightness enhancement sheet comprises a plurality of parallel V-shaped prisms, and the V-shaped prisms cross the V-shaped grooves of the light guide plate.

17. A backlight module comprising:
a light guide plate comprising:
a rectangular substrate defining thereof long and short sides perpendicular to each other, and said substrate having an incident surface and an emitting surface; and
a plurality of first parallel V-shaped grooves provided at the emitting surface;
a light source disposed adjacent to the incident surface of the light guide plate;
a brightness enhancement sheet located on the other side of the light guide plate, opposite to the light source, said brightness enhancement sheet being sized and configured to be similar to said substrate;
a plurality of second parallel V-shaped grooves provided on the brightness enhancement sheet; wherein
both said first V-shaped grooves and said second V-shaped grooves do not extend along the corresponding long side or the corresponding short side thereof, and also do not extend perpendicular to each other.

18. The backlight module as claimed in claim 17, wherein each of the first V-shaped grooves maintains an oblique angle relative to the corresponding long side of the substrate, and the angle is smaller than 45 degrees.

19. The backlight module as claimed in claim 17, wherein each of the first V-shaped grooves maintains an oblique angle relative to the corresponding long side of the brightness enhancement sheet, and the angle is smaller than 45 degrees.
